(19) United States
(12) Patent Application Publication
(10) Pub. No.: US 2009/0031196 A1
(43) Pub. Date: Jan. 29, 2009

(54) Error-correcting method used for decoding data transmissions

(75) Inventor: Chien-Te Hsu, Taipei County (TW)

Correspondence Address: Joe McKinney Muncy, PO Box 1364, Fairfax, VA, 22038-1364, US

(73) Assignee: PRINCETON TECHNOLOGY CORPORATION

(21) Appl. No.: 11/907,495

(22) Filed: Oct. 12, 2007

(30) Foreign Application Priority Data
Jul. 24, 2007 (TW) 096126904

(51) Int. Cl. G06F 11/07

(52) U.S. Cl. 714/781; 714/E11.021

(57) ABSTRACT

An error-correcting method used for decoding of data transmissions is disclosed. The error-correcting method is used for data with an error-correcting part and comprises: providing a multinomial for processing an error-correcting part to get an operational result; providing a database for saving the corresponding operational results of each single bit; and finding the error bit according to the operational results.

### BACKGROUND OF THE INVENTION

1. Field of the Invention

The invention relates to an error-correcting method used for decoding of data transmissions, and more particularly to an error-correcting method capable of addressing.

2. Description of the Related Art

During poor or interrupted data transmissions, should data sent from a transmitter be different from data received by a receiver, an error-correcting operation would be performed, enabling the received data by the receiver to be corrected.

Generally, an error-correcting operation compares error data received by the receiver with correct data from a lookup table. A match is designated based upon the most similar data in the lookup table to the error data and then a correction is made. However, the method requires considerable storage memory for required databases, hardware for required calculations, and time for processing, thus, the method is relatively costly.

As such, a more efficient error-correcting method used for decoding data transmissions is desirable.

### BRIEF SUMMARY OF THE INVENTION

The invention provides error-correcting methods. An exemplary embodiment of an error-correcting method comprises: providing a multinomial for processing an error-correcting part of the data to get a result; providing a database for saving the result corresponding to each single bit of the data; and finding the error bit according to the result.

Another embodiment of an error-correcting method comprises: providing a data with an error-correcting part; providing a multinomial for the error-correcting part to get an operational result; and providing a database for locating a single error bit corresponding to the operational result.

Another embodiment of an error-correcting method comprises: providing a data with an error-correcting part; providing a multinomial for processing the error-correcting part to get an operational result; determining whether the operational result is 0; if the operational result is 0, the data represents correct data; and, if the operational result is not 0, locating a data error bit corresponding to the operational result using a database.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of a coding data structure; and

FIG. 2 is a schematic view of an embodiment of a multinomial G(X)=x¹⁰+x³+1 operational structure.

### DETAILED DESCRIPTION OF THE INVENTION

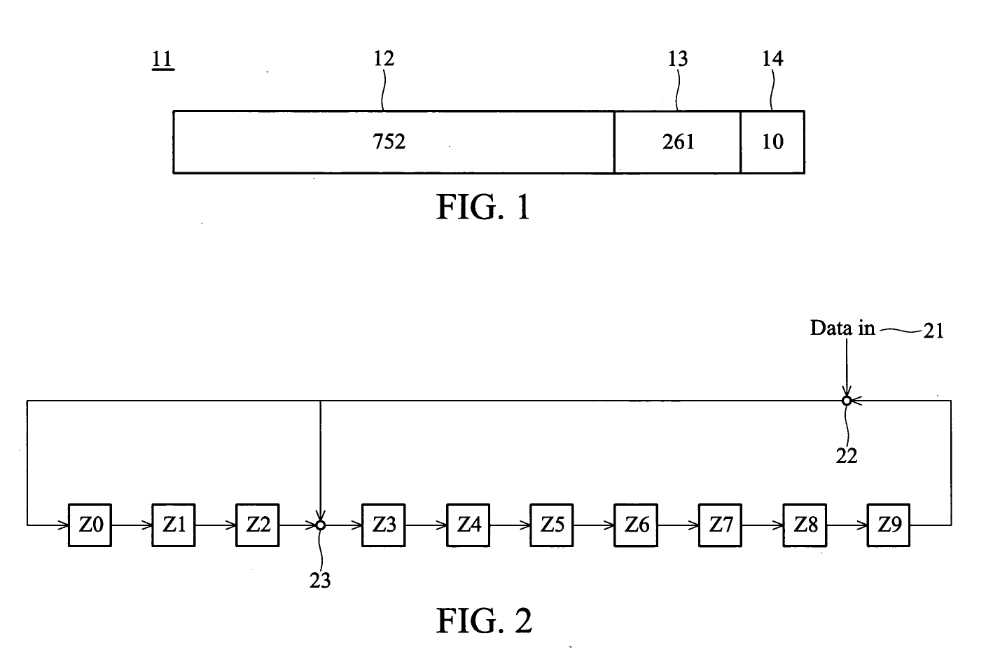

Several exemplary embodiments of the invention are described with reference to FIGS. 1 and 2, which generally relate to error-correcting for decoding of data transmissions. It is to be understood that the following disclosure provides various different embodiments as examples for implementing different features of the invention. Specific examples of components and arrangements are described in the following to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses an error-correcting method used for decoding of data transmissions.

During data transmissions, raw data is encoded by a transmitter and transmitted to a receiver for decoding and error-correcting. In this embodiment, 752-bits raw data is used to describe the error-correcting method, but is not to be limitative.

The 752-bits of raw data are encoded by the transmitter and become 1,013-bits of encoded data by adding 261-bits of “0” data. Next, at least 10 bits of error-correcting part is added to the 1,013-bits to become 1,024-bits of encoded data. FIG. 1 is a schematic view of an embodiment of a coding data structure.

Referring to FIG. 1, encoded data 11 comprises 752-bits of raw data 12,261-bits “0” data 13, and at least 10-bits error-correcting part 14. “0” data is added to the raw data to equal 1,013-bits of encoded data. The number of bits for the error-correcting part 14 must at least correspond to the number of bits of raw data. In the embodiment, since each bit can be either “0” or “1”, the error-correcting part 14 should comprise of at least 10 bits to correspond with all possible results (2¹⁰=1,024) of each bit.

A multinomial G(X)=x¹⁰+x³+1 is determined by the bit number of the error-correcting part 14, and is used by error-correcting part 14 to generate an operational result. FIG. 2 is a schematic view of an embodiment of a multinomial G(X)=x¹⁰+x³+1 operational structure. Referring to FIG. 2, 10 bits of error-correcting part 14 is represented by Z0˜Z9. The multinomial comprises an input 21 and two XOR (Exclusive OR) gates 22 and 23. XOR gate 22 is installed between bits Z9 and Z0 while XOR gate 23 is installed between bits Z2 and Z3. Data of bits Z0˜Z9 is preset as “0”. Each clock inputs 1-bit data in input 21. For each clock input, XOR processing is conducted once for the parts between Z9 and Z0 and between Z2 and Z3. The remaining parts are adjusted backward by one position based on the bit data sequence. For example, when clock=0, data of bits Z0˜Z9 is preset as “0”, when clock=1, input data to input 21 is 1 and data “1” is obtained by implementing XOR processing to 1 and Z9. Next, a shift is conducted whereby Z0 is equal to 1. Following, data originally stored in Z0 is shifted to Z1 and data originally stored in Z1 is shifted to Z2 so that data of Z1 and Z2 is both equal to 0. Further, by XOR processing data of Z3 is equal to 1, while data of Z4˜Z9 are all equal to 0. The described method details the operations to the error-correcting part 14 using the multinomial G(X)=x¹⁰+x³+1, in which each clock inputs data (bit 1 to 1,013) and corresponds to a corresponding result of the error-correcting part 14. If the final result of the multinomial G(X)=x¹⁰+x³+1 is equal to 0, no bit error is assumed to have occurred,

When an error for one of bits 1˜1,013 occurs, the result of the multinomial G(X)=x¹⁰+x³+1 will not equal 0. Comparisons will be made with corresponding operational results of the error-correcting part 14 to locate the error bit. For example, for Z0˜Z9, say an error occurs in the 13^{th} bit an equals 0001000001. Thus, when the operational result of the error-correcting part 14 is 0001000001, the 13^{th} bit is expected as being an error, and an error-correcting operation is performed.

Since each bit error corresponds to an operational result of the error-correcting part, a database is required to record all corresponding operational results of each bit error. The operation of the error-correcting part is complete when a final result is not equal to 0. A bit generating an error bit is located based upon corresponding operational results in the database, and operational results of the error-correcting operation.

The described embodiments are capable of accurately and efficiently implementing error-correcting operations with. reduced storage. memory, hardware, and processing time, thus, the making the methods of the invention relatively less costly.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An error-correcting method used for decoding of data transmissions, comprising:
providing a multinomial for processing an error-correcting part of the data to get a result;
providing a database for saving the result corresponding to each single bit of the data; and
finding the error bit according to the result.

2. The error-correcting method used for decoding of data transmissions as claimed in claim 1, wherein the multinomial is determined according to the bit number of the error-correcting part.

3. The error-correcting method used for decoding of data transmissions as claimed in claim 1, wherein the bit number of the error-correcting part is 10 and the multinomial is represented as G(X)=x¹⁰+x³+1.

4. The error-correcting method used for decoding of data transmissions as claimed in claim 1, wherein the data is correct when the result is equal to 0.

5. The error-correcting method used for decoding of data transmissions as claimed in claim 1, wherein the multinomial provides two XOR (Exclusive OR) gate processing.

6. The error-correcting method used for decoding of data transmissions as claimed in claim 1, wherein the method is applied to the data comprising one bit error.

7. An error-correcting method used for decoding of data transmissions, comprising:
providing a data with an error-correcting part;
providing a multinomial for the error-correcting part to get an operational result; and
providing a database for locating a single error bit corresponding to the operational result.

8. The error-correcting method used in decoding for data transmissions as claimed in claim 7, wherein the multinomial is determined according to the bit number of the error-correcting part.

9. The error-correcting method used for decoding of data transmissions as claimed in claim 7, wherein the bit number of the error-correcting part is 10 and the multinomial is represented as G(X)=x¹⁰+x³+1.

10. The error-correcting method used for decoding of data transmissions as claimed in claim 7, wherein the data is correct when the operational result is equal to 0.

11. The error-correcting method used for decoding of data transmissions as claimed in claim 7, wherein the multinomial provides two XOR (Exclusive OR) gate processing.

12. The error-correcting method used for decoding of data transmissions as claimed in claim 7, wherein the method is applied to the data comprising one bit error.

13. An error-correcting method used for decoding of data transmissions, comprising:
providing a data with an error-correcting part;
providing a multinomial for processing the error-correcting part to get an operational result;
determining whether the operational result is 0;
if the operational result is 0, the data is correct; and
if the operational result is not 0, locating a data error bit corresponding to the operational result by using a database.

14. The error-correcting method used for decoding of data transmissions as claimed in claim 13, wherein the multinomial is determined according to the bit number of the error-correcting part.

15. The error-correcting method used for decoding of data transmissions as claimed in claim 13, wherein the bit number of the error-correcting part at least equals to the bit number of the data.

16. The error-correcting method used for decoding of data transmissions as claimed in claim 13, wherein the bit number of the error-correcting part is 10 and the multinomial is represented as G(X)=x¹⁰+x³+1.

17. The error-correcting method used for decoding of data transmissions as claimed in claim 13, wherein the multinomial provides two XOR (Exclusive OR) gate processing.

18. The error-correcting method used for decoding of data transmissions as claimed in claim 13, wherein the method is applied to the data comprising one bit error.
